(19) United States
(12) Patent Application Publication
(10) Pub. No.: US 2014/0069383 A1
(43) Pub. Date: Mar. 13, 2014

(54) CONTROLLER FOR ENGINE

(71) Applicants: Daisuke TSUTSUI, Tokai-shi (JP); Takao KOMODA, Okazaki-shi (JP)

(72) Inventors: Daisuke TSUTSUI, Tokai-shi (JP); Takao KOMODA, Okazaki-shi (JP)

(73) Assignees: TOYOTA JIDOSHA KABUSHIKI KAISHA, Toyota-shi (JP); AISAN KOGYO KABUSHIKI KAISHA, Obu-shi (JP)

(21) Appl. No.: 14/022,489

(22) Filed: Sep. 10, 2013

(30) Foreign Application Priority Data
Sep. 13, 2012 (JP) 2012-201259

(51) Int. Cl. F02D 41/00

(52) U.S. Cl. CPC F02D 41/0027
USPC 123/435

(57) ABSTRACT

A bi-fuel engine is selectively operable in a first operation mode that uses liquid fuel and a second operation mode that uses gas fuel. A controller for the engine is configured to start a depressurizing process that supplies at least one of the cylinders with gas fuel as pressure of the gas fuel becomes greater than or equal to an initiation determination value when the engine is operating in the first operation mode.

### BACKGROUND OF THE INVENTION

The technology of the present disclosure relates to a controller for a bi-fuel engine capable of using liquid fuel and gas fuel.

Japanese Laid-Open Patent Publication No. 2005-214079 describes an example of a bi-fuel engine. Such a bi-fuel engine includes a first injection valve that injects liquid fuel such as gasoline and a second injection valve that injects gas fuel such as compressed natural gas (CNG).

When the engine is in a first operation mode that uses liquid fuel, the first injection valve injects liquid fuel. In the first operation mode, injection of gas fuel from the second injection valve is prohibited. When the engine is in a second operation mode that uses gas fuel, the second injection valve injects gas fuel. In the second operation mode, injection of liquid fuel from the first injection valve is prohibited.

### SUMMARY OF THE INVENTION

When a vehicle is driven over a long distance, for example, between cities, the engine may be operated in the first operation mode over a long period to lower fuel consumption. In this case, the combustion of an air-fuel mixture including the liquid fuel in the combustion chambers generates heat that is transmitted through the first injection valve to a supply system for the gas fuel. This raises the temperature of the gas fuel in a delivery pipe that forms the supply system. Since the gas fuel in the delivery pipe is not used when the engine is in the first operation mode, the pressure of the gas fuel gradually increases.

The second injection valve includes a valve body that becomes difficult to open when the pressure of the gas fuel applied to a back surface of the valve body increases. In this manner, when the pressure of the gas fuel is high, more electric power is used to open the second injection valve.

Thus, when the operation mode shifts to the second operation mode after the first operation mode continues for a long period and the pressure of the fuel gas is thereby high in the delivery pipe, more electric power is consumed to inject gas fuel from the second injection valve than when the pressure of the gas fuel is not high.

It is an object of the present disclosure to provide a controller for an engine that decreases the amount of electric power consumed to supply gas fuel to the cylinders of the engine when shifting from an operation mode that uses liquid fuel to an operation mode that uses gas fuel.

One object of the present invention is a controller for a bi-fuel engine. The engine includes a plurality of cylinders and is selectively operable in a first operation mode that uses liquid fuel and a second operation mode that uses gas fuel. The controller is configured to start a depressurizing process that supplies at least one of the cylinders with the gas fuel if a pressure of the gas fuel becomes greater than or equal to an initiation determination value when the engine is operating in the first operation mode.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a bi-fuel engine and a controller in a first embodiment;

FIG. 2 is a flowchart of a processing routine performed to set the initiation timing and the termination timing of a depressurizing process in the first embodiment;

FIG. 3 is a timing chart showing how the delivery fuel pressure of CNG changes when the depressurizing process is initiated while the engine is operating in the gasoline operation mode; and

FIG. 4 is a flowchart showing a processing routine performed to set the initiation timing and the termination timing of a depressurizing process in a second embodiment.

### DETAILED DESCRIPTION OF THE INVENTION

### First Embodiment

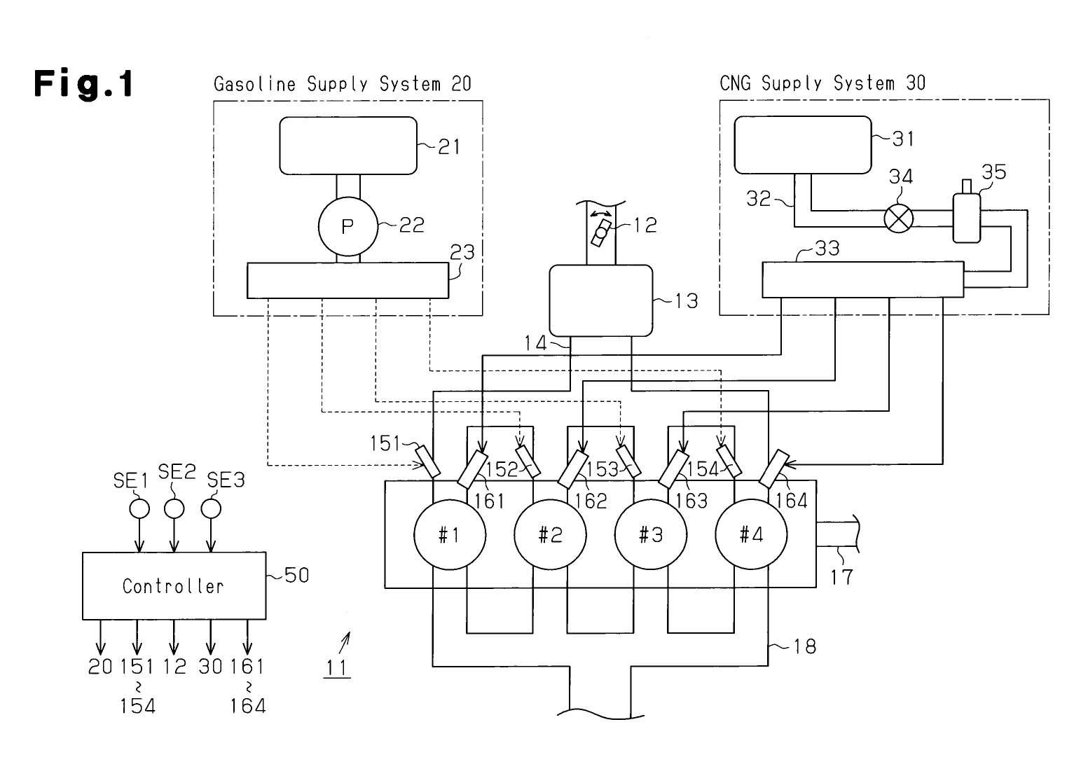

A controller for an engine according to a first embodiment of the present disclosure will now be described with reference to FIGS. 1 to 3.

Referring to FIG. 1, a bi-fuel engine 11 includes a gasoline supply system 20 and a CNG supply system 30. The gasoline supply system 20 serves as a liquid fuel supply system that supplies gasoline as liquid fuel. The CNG supply system 30 serves as a gas fuel supply system that supplies compressed natural gas (CNG) as gas fuel. An intake passage supplies intake air to cylinders #1, #2, #3, and #4 of the engine 11. An air cleaner (not shown), a throttle valve 12, and a surge tank 13 are sequentially arranged in the intake passage from the upstream side to the downstream side in the flow direction of the intake air. An intake manifold 14 is arranged downstream to the surge tank 13. The intake manifold 14 distributes the flow of intake air in the intake passage to cylinders #1 to #4.

The intake manifold 14 includes branching passages that supply intake air to cylinders #1 to #4. Gasoline injection valves 151, 152, 153, and 154, which inject gasoline, and CNG injection valves 161, 162, 163, and 164, which inject CNG, are arranged in the branching passages for cylinders #1 to #4, respectively. The combustion of an air-fuel mixture of the intake air and gasoline or CNG in combustion chambers of cylinders #1 to #4 rotates an output shaft of the engine 11, namely, a crankshaft 17, in a predetermined rotation direction.

The combustion of the air-fuel mixture in cylinders #1 to #4 generates exhaust. The exhaust is discharged from an exhaust passage formed by an exhaust manifold 18.

The gasoline supply system 20 includes a fuel pump 22, which draws gasoline from a gasoline tank 21, and a gasoline delivery pipe 23, which delivers the gasoline discharged from the fuel pump 22 under pressure. The gasoline injection valves 151 to 154 are supplied with gasoline from the gasoline delivery pipe 23.

The CNG supply system 30 includes a high-pressure fuel pipe 32, which is connected to a CNG tank 31, and a CNG delivery pipe 33, which is connected to a downstream end of the high-pressure fuel pipe 32. The high-pressure fuel pipe 32 includes a shutoff valve 34, which opens when the engine 11 runs on CNC and closes when the engine 11 runs on gasoline, and a regulator 35, which is arranged downstream to the shutoff valve 34. The regulator 35 functions to supply the CNG delivery pipe 33 with CNG under a regulated fuel pressure. In the present embodiment, the fuel pressure regulated by the regulator 35 is referred to as the system fuel pressure PDcmin.

A controller 50 for the engine 11 will now be described.

Referring to FIG. 1, the controller 50 is electrically connected to a pressure sensor SE1, which detects the fuel pressure in the CNG delivery pipe 33, an accelerator sensor SE2, which detects the amount an accelerator pedal is depressed by a driver, and a crank angle sensor SE3, which detects the rotation speed of the crankshaft 17. Further, the controller 50 is electrically connected to the gasoline supply system 20 (specifically, the fuel pump 22 and the like), the shutoff valve 34 of the CNG supply system 30, the gasoline injection valves 151 to 154, the CNG injection valves 161 to 164, and the like.

The controller 50 includes a microcomputer formed by a CPU, ROM, and RAM (not shown). The ROM stores various control programs executed by the CPU. The RAM temporarily stores rewritable information when an ignition switch (not shown) of the vehicle is ON.

The engine 11 of the present embodiment is capable of operating in a gasoline operation mode (first operation mode) that uses gasoline and a CNG operation mode (second operation mode) that uses CNG. When the engine 11 is in the gasoline operation mode, the injection of CNG from the CNG injection valves 161 to 164 is prohibited. Thus, the CNG injection valves 161 to 164 transmit the heat generated during operation of the engine 11 to the CNG delivery pipe 33. This raises the temperature of the CNG in the CNG delivery pipe 33 and raises the pressure of the CNG in the CNG delivery pipe 33, namely, the delivery fuel pressure PDc. As a result, the pressure applied to the back surface of the valve body (not shown) of each of the CNG injection valves 161 to 164 increases. Thus, the CNG injection valves 161 to 164 may have to generate a larger electromagnetic force to inject CNG. In other words, the amount of electric power consumed to operate the CNG injection valves 161 to 164 may be increased.

Thus, in the present embodiment, if the delivery fuel pressure PDc becomes high when the engine 11 is in the gasoline operation mode, a depressurizing process is initiated to supply at least one of cylinders #1 to #4 (in the present embodiment, first cylinder #1) with CNG instead of gasoline. The execution of the depressurizing process discharges small amounts of CNG from the CNG delivery pipe 33 to decrease the delivery fuel pressure PDc.

In the depressurizing process, the shutoff valve 34 opens so that the CNG delivery fuel pressure PDc does not become excessively low. This allows for the CNG delivery pipe 33 to be supplied with pressure-regulated CNG from the regulator 35.

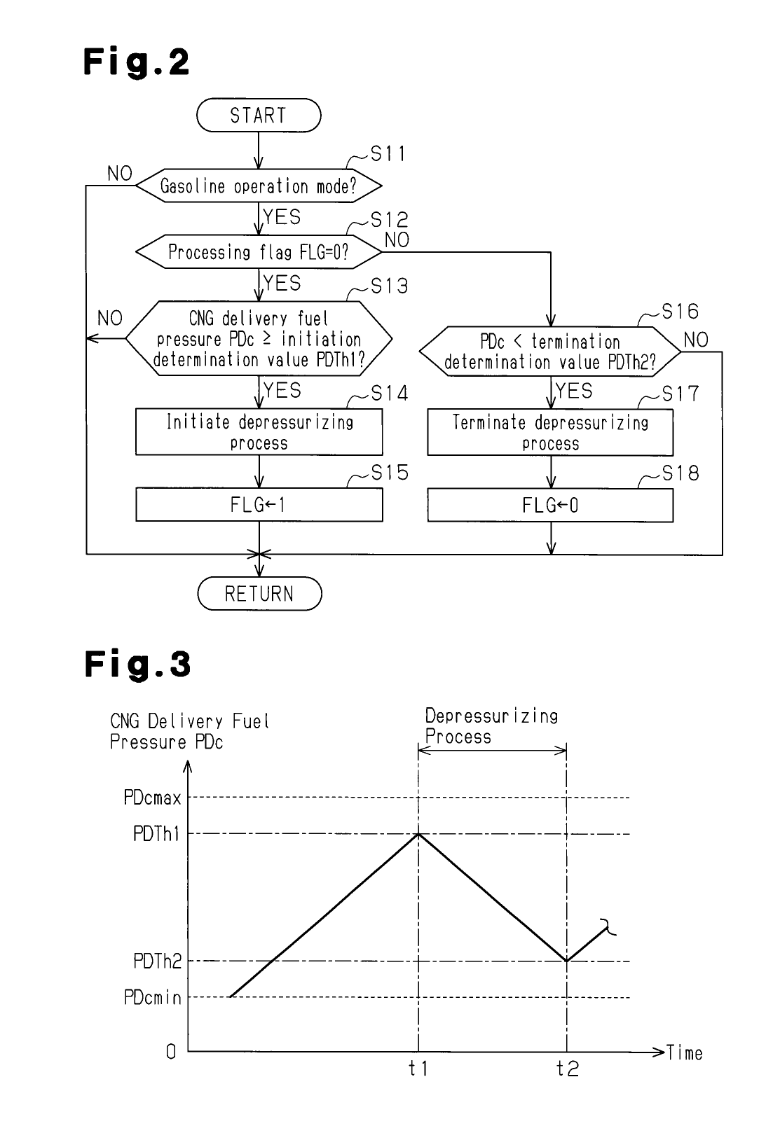

A processing routine executed by the controller 50 when setting the initiation timing and the termination timing of the depressurizing process will now be described with the reference to the flowchart of FIG. 2. The processing routine is executed in predetermined cycles.

In the processing routine shown in FIG. 2, the controller 50 determines whether or not the engine 11 is in the gasoline operation mode (step S11). When the engine 11 is not in the gasoline operation mode (step S11: NO), the engine is in the CNG operation mode. Thus, the controller 50 temporarily terminates the present processing routine. When the engine 11 is in the gasoline operation mode (step S11: YES), the controller 50 determines whether or not a processing flag FLG is “0 (zero)” (step S12). The processing flag FLG is set to “1” when the depressurizing process is executed.

When the pressurizing flag FLG is set to “1” (step S12: NO), the depressurizing process is being executed. In this case, the controller 50 proceeds to step S16. When the pressuring flag FLG is set to “0 (zero)” (step S12: YES), the depressurizing process is not being executed. Thus, the controller 50 obtains the CNG delivery fuel pressure PDc based on a detection signal from the pressure sensor SE1 and determines whether or not the delivery fuel pressure PDc is greater than or equal to a preset initiation determination value PDTh1 (step S13). The initiation determination value PDTh1 is set to be smaller than a valve opening limit pressure PDcmax of the CNG injection valves 161 to 164. The valve opening limit pressure PDcmax refers to the delivery fuel pressure PDc at which CNG can no longer be injected from the CNG injection valves 161 to 164.

When the delivery fuel pressure PDc is less than the initiation determination value PDTh1 (step S13: NO), the controller 50 temporarily terminates the present processing routine. When the delivery fuel pressure PDc is greater than or equal to the initiation determination value PDTh1 (step S13: YES), the controller 50 initiates the depressurizing process (step S14). Then, the controller 50 sets the processing flag FLG to “1” (step S15) and temporarily terminates the present processing routine.

In step S16, the controller 50 determines whether or not the CNG delivery fuel pressure PDc is less than a termination determination value PDTh2. The termination determination value PDTh2 is set at a pressure that is smaller than the initiation determination value PDTh1 and larger than the system fuel pressure PDcmin. When the delivery fuel pressure PDc is greater than or equal to the termination determination value PDTh2 (step S16: NO), the controller 50 temporarily terminates the present processing routine and continues the depressurizing process.

When the delivery fuel pressure PDc is less than the termination determination value PDTh2 (step S16: YES), the delivery fuel pressure PDc is sufficiently low. Thus, the controller 50 terminates the depressurizing process (step S17). Then, the controller 50 sets the processing flag FLG to “0 (zero)” (step S18) and temporarily terminates the present processing routine.

The operation of the engine 11 in the gasoline operation mode will now be described with reference to the timing chart of FIG. 3.

When the engine is operating in the gasoline operation mode, the combustion of the air-fuel mixture that includes gasoline in cylinders #1 to #4 generates heat that is transmitted to the CNG supply system 30, and the temperature of the CNG in the CNG delivery pipe 33 rises. This increases the CNG delivery fuel pressure PDc because the injection of CNG from the CNG injection valves 161 to 164 is prohibited.

Referring to FIG. 3, the depressurizing process is initiated at a first timing t1 when the delivery fuel pressure PDc becomes greater than or equal to an initiation determination value PDTh1, which is lower than the valve opening limit pressure PDcmax. As a result, among cylinders #1 to #4, cylinders #2 to #4 are continuously supplied with gasoline, while cylinder #1 is supplied with CNG instead of gasoline. That is, even when the engine 11 is operating in the gasoline operation mode, CNG is injected from the CNG injection valve 161. Thus, the CNG in the CNG delivery pipe 33 is consumed in small amounts.

When the engine 11 is in the gasoline operation mode, CNG is usually not used. Thus, the shutoff valve 34 stops the supply of CNG from the CNG tank 31 to the CNG delivery pipe 33. However, when the depressurizing process is initiated, the shutoff valve 34 opens even when the engine 11 is in the gasoline operation mode. This allows for CNG to be supplied from the CNG tank 31 to the CNG delivery pipe 33.

When the depressurizing process is initiated at the first timing t1, the delivery fuel pressure PDc gradually decreases as time elapses. At timing t2, when the delivery fuel pressure PDc becomes less than the termination determination value PDTh2, the depressurizing process is terminated. Here, if the engine 11 is still in the gasoline operation mode, the injection of CNG from the CNG injection valve 161 into the first cylinder #1 is stopped, and gasoline is injected from the gasoline injection valve 151. Further, since the supply of CNG is stopped, the shutoff valve 34 is closed, and the supply of CNG from the CNG tank 31 to the CNG delivery pipe 33 is prohibited.

Subsequently, when the engine 11 shifts from the gasoline operation mode to the CNG operation mode, cylinders #1 to #4 are supplied with CNG instead of gasoline. Here, the delivery fuel pressure PDc is smaller than the initiation determination value PDTh1. Thus, in comparison with when the CNG injection valves 161 to 164 inject CNG under a situation in which the delivery fuel pressure PDc is greater than or equal to the initiation determination value PDTh1, the engine 11 operates in the CNG operation mode while suppressing increases in the amount of electric power consumed by the CNG injection valves 161 to 164.

The present embodiment has the advantages described below.

(1) As the CNG delivery fuel pressure PDc becomes greater than or equal to the initiation determination value PDTh1 when the engine 11 is operating in the gasoline operation mode, the depressurizing process is initiated, and cylinder #1 is supplied with CNG instead of gasoline. This decreases the CNG delivery fuel pressure PDc when the engine 11 is being operated in the first operation mode. Thus, when the engine 11 subsequently shifts from the gasoline operation mode to the CNG operation mode, the delivery fuel pressure PDc is less than the initiation determination value PDTh1. This allows for the CNG injection valves 161 to 164 to be operated without increasing the consumption amount of electric power.

(2) In the present embodiment, the depressurizing process is terminated when the delivery fuel pressure PDc becomes less than the termination determination value PDTh2. This reduces hunting, which is a continuous repetition of the initiation and termination of the depressurizing process, as compared with when the depressurizing process is terminated at a timing at which the delivery fuel pressure PDc becomes less than the initiation determination value PDTh1.

(3) During the depressurizing process, the shutoff valve 34 opens to permit the supply of CNG from the CNG tank 31 to the CNG delivery pipe 33. This suppresses situations in which the delivery fuel pressure PDc becomes less than the system fuel pressure PDcmin during the depressurizing process. Accordingly, when a CNG injection valve injects CNG, the CNG injection valve can inject the required amount of CNG.

(4) In the present embodiment, the initiation determination value PDTh1 is set as a value that is less than the valve opening limit pressure PDcmax. Thus, during the first operation mode, when the engine 11 shifts from the gasoline operation mode to the CNG operation mode before the depressurizing process is initiated, a situation in which the CNG delivery fuel pressure PDc is greater than the valve opening limit pressure PDcmax is avoided. This suppresses CNG injection failures when the engine 11 operates in the CNG operation mode.

(5) The depressurizing process is executed when the engine 11 is in the first operation mode. This avoids an increase in the amount of electric power used to actuate the CNG injection valves 161 to 164 when the engine 11 operates in the second operation mode. Thus, injection valves having a lower valve opening limit pressure PDcmax may be used as the CNG injection valves. Further, a circuit having a relatively poor pressure increasing property may be used as a pressure increasing circuit for the CNG injection valve 161.

(6) When the CNG delivery fuel pressure PDc is greater than or equal to the initiation determination value PDTh1, the engine 11 seldom shifts to the CNG operation mode. Thus, when the engine 11 operates in the CNG operation mode, a high-pressure state is avoided in which the delivery fuel pressure PDc is greater than or equal to the initiation determination value PDTh1. This allows for the CNG injection amount to be adjusted with high accuracy.

### Second Embodiment

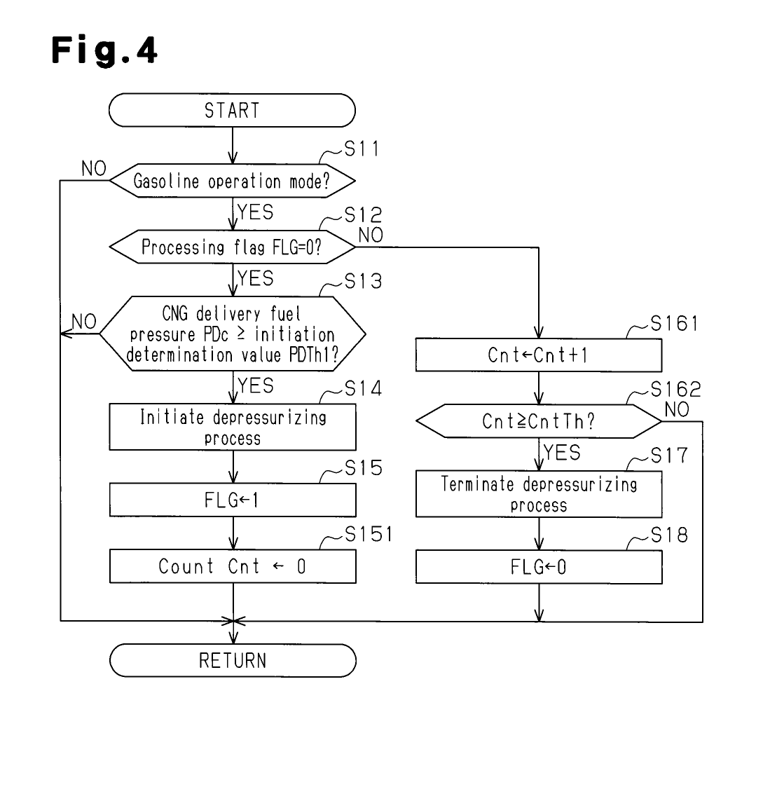

A second embodiment of the present invention will now be described with reference to FIG. 4. The second embodiment differs from the first embodiment in how the termination timing of the depressurizing process is set. Like or same reference numerals are given to those components that are the same as the corresponding components of the first embodiment. Such components will not be described in detail.

In the present embodiment, when the engine 11 is operated in the gasoline operation mode and the depressurizing process is initiated, the depressurizing process is terminated when a specified time elapses from when the depressurizing process is initiated. The specified period is set in advance in accordance with the characteristics of the vehicle through experiments and simulations.

A processing routine executed by the controller 50 when setting the initiation timing and the termination timing of the depressurizing process will now be described with reference to the flowchart of FIG. 4. The processing routine is executed in predetermined cycles.

In the processing routine illustrated in FIG. 4, when the engine 11 is in the gasoline operation mode (step S11: YES) and the processing flag FLG is “1” (step S12: NO), the controller 50 proceeds to step S161. When the engine 11 is in the gasoline operation mode (step S11: YES) and the processing flag FLG is “0 (zero)” (step S12; YES), the controller 50 proceeds to step S13.

When the CNG delivery fuel pressure PDc is greater than or equal to the initiation determination value PDTh1 (step S13: YES), the controller 50 starts the depressurizing process (step S14) and sets the processing flag FLG to “1”(step S15). Then, the controller 50 sets a count Cnt to “0 (zero)” (step S151) and temporarily terminates the present processing routine. The count Cnt corresponds to the elapsed time from when the depressurizing process is initiated.

In step S161, the controller 50 increments the count Cnt by “1.” Then, the controller 50 determines whether or not the updated count Cnt is greater than or equal to a count determination value CntTh that corresponds to the specified time described above (step S162). When the count Cnt is less than the count determination value CntTh (step S162: NO), the termination condition of the depressurizing process is unsatisfied. That is, the execution time of the depressurizing process has not reached the specified time. Thus, the controller 50 temporarily terminates the present processing routine.

When the count Cnt is greater than or equal to the count determination value CntTh (step S162: YES), the termination condition of the depressurizing process is satisfied. That is, the execution time of the depressurizing process has reached the specified time. Thus, the controller 50 terminates the depressurizing process (step S17). Then, the controller 50 sets the processing flag FLG to “0 (zero)” (step S18) and temporarily terminates the present processing routine.

As described above, the present embodiment obtains the following advantage in addition to advantages (1) and (3) to (6) of the first embodiment.

(7) In the present embodiment, when the depressurizing process is initiated, the controller 50 starts updating the count Cnt, which corresponds to the elapsed time from when the depressurizing process is initiated. The depressurizing process is terminated when the count Cnt becomes greater than or equal to the count determination value CntTh. This reduces hunting, which is a continuous repetition of the initiation and termination of the depressurizing process, as compared with when the depressurizing process is terminated at a timing at which the delivery fuel pressure PDc becomes less than the initiation determination value PDTh1.

It should be apparent to those skilled in the art that the present invention may be embodied in many other specific forms without departing from the spirit or scope of the invention. Particularly, it should be understood that the present invention may be embodied in the following forms.

In the second embodiment, during execution of the depressurizing process, when the CNG delivery fuel pressure PDc becomes less than or equal to the termination determination value PDTh2 before the count Cnt becomes greater than or equal to the count determination value CntTh, the depressurizing process may be terminated before the count Cnt reaches the count determination value CntTh.

In the first embodiment, the shutoff valve 34 may remain closed during the depressurizing process. In this case, the depressurizing process may be terminated before the delivery fuel pressure PDc becomes less than or equal to the system fuel pressure PDcmin. Thus, CNG injection failures may be suppressed during the depressurizing process.

In each of the above embodiments, the depressurizing process may supply some of cylinders #1 to #4 with CNG instead of gasoline. For example, two or three cylinders may be supplied with CNG instead of gasoline.

In each of the above embodiments, cylinders #1 to #4 may all be supplied with CNG instead of gasoline in the depressurizing process.

In each of the above embodiments, the increasing speed of the CNG delivery fuel pressure PDc may be monitored. If the increasing speed is high when initiating the depressurizing process, the number of cylinders supplied with CNG may be increased as compared to when the increasing speed is low. This allows for the delivery fuel pressure PDc to be decreased when the depressurizing process is executed.

In each of the above embodiments, if the CNG delivery fuel pressure PDc does not decrease even though the depressurizing process is executed, the number of cylinders supplied with CNG may be increased. This allows for the execution of the depressurizing process to decrease the delivery fuel pressure PDc.

In each of the above embodiments, when the engine 11 shifts to the CNG operation mode during execution of the depressurizing process, the depressurizing process may be terminated at that moment.

In each of the above embodiments, the depressurizing process may be continued until the engine 11 shifts from the gasoline operation mode to the CNG operation mode.

In each of the above embodiments, during the depressurizing process, at least one of the cylinders may be supplied with gasoline and CNG.

In each of the above embodiments, the gas fuel is not restricted to CNG and may be hydrogen gas, liquefied petroleum gas (LPG), and the like. For example, when the gas fuel is hydrogen gas, the liquid fuel may be gasoline. When the gas fuel is dimethyl ether (DME), the liquid fuel may be light oil such as diesel oil.

The present examples and embodiments are to be considered as illustrative and not restrictive, and the invention is not to be limited to the details given herein, but may be modified within the scope and equivalence of the appended claims.

What is claimed is:

1. A controller for a bi-fuel engine, wherein the engine includes a plurality of cylinders and is selectively operable in a first operation mode that uses liquid fuel and a second operation mode that uses gas fuel,
wherein the controller is configured to start a depressurizing process that supplies at least one of the cylinders with the gas fuel if a pressure of the gas fuel becomes greater than or equal to an initiation determination value when the engine is operating in the first operation mode.

2. The controller according to claim 1, wherein the controller is configured to terminate the depressurizing process when the pressure of the gas fuel becomes less than a termination determination value that is smaller than the initiation determination value.

3. The controller according to claim 1, wherein the controller is configured to terminate the depressurizing process when a specified time elapses from when the depressurizing process is initiated.

4. The controller according to claim 1, wherein
the engine includes an injection valve and a gas fuel supply system that supplies gas fuel to the injection valve,
the gas fuel system includes a delivery pipe that supplies gas fuel to the injection valve and a regulator that supplies the delivery pipe with pressure-regulated gas fuel, and
the controller is configured to allow the delivery pipe to be supplied with the pressure-regulated gas fuel from the regulator.

5. The controller according to claim 4, wherein the controller is configured to terminate the depressurizing process when the pressure of the gas fuel becomes less than a termination determination value that is higher than the pressure-regulated gas fuel from the regulator.

6. The controller according to claim 4, wherein
the injection valve is configured to prohibit valve opening when the pressure of the gas fuel supplied to the injection valve is greater than or equal to a valve opening limit pressure, and
the initiation determination value is set to be less than the valve opening limit pressure.

7. The controller according to claim 1, wherein
the engine includes an injection valve that supplies gas fuel to the engine,
the injection valve is configured to prohibit valve opening when the pressure of the gas fuel supplied to the injection valve is greater than or equal to a valve opening limit pressure, and
the initiation determination value is set to be smaller than the valve opening limit pressure.

8. The controller according to claim 1, wherein the depressurizing process supplies only some of the cylinders with gas fuel.

9. A system comprising:
a bi-fuel engine having cylinders, the engine is selectively operable in a first operation mode that uses a liquid fuel and a second operation mode that uses a gas fuel;
a controller operative to start a depressurizing process that supplies a cylinder with the gas fuel if a pressure of the gas fuel is greater than an initiation determination value when the engine is operating in the first operation mode.
